(19) United States
(12) Patent Application Publication
(10) Pub. No.: US 2021/0253011 A1
(43) Pub. Date: Aug. 19, 2021

(54) VEHICULAR MATTRESS SUPPORT PLATFORM AND METHOD OF MAKING

(71) Applicant: Inteva Products, LLC, Troy, MI (US)

(72) Inventors: Brian H. Staser, Oxford, MI (US); Lisa Marie Hopman, Oxford, MI (US)

(21) Appl. No.: 17/177,582

(22) Filed: Feb. 17, 2021

Related U.S. Application Data
(60) Provisional application No. 62/977,820, filed on Feb. 18, 2020.

(51) Int. Cl. B60N 3/00; B60P 3/38

(52) U.S. Cl. CPC B60N 3/008; A47C 21/00; B60P 3/38

(57) ABSTRACT

Disclosed is a mattress support platform comprising a perimeter portion and a central portion, wherein the central portion comprises ribs and open spaces located between the ribs and further wherein the perimeter portion and the central portion are formed from a reinforced polymer composition. Also disclosed are methods of making a mattress support platform.

### CROSS-REFERENCE TO RELATED APPLICATIONS

This application claims the benefit of U.S. Provisional Application Ser. No. 62/977,820, filed Feb. 18, 2020, the disclosure of which is incorporated herein by reference in its entirety.

### BACKGROUND

Exemplary embodiments pertain to the art of mattress supports, particularly for a vehicle.

In various vehicles, especially in trucks and commercial vehicles, there is often a need to provide one or more sleeping areas within the vehicle. By way of example, vehicles can often include one or more sleeper bunks or berths so one member of a driving team can rest while the other operates the vehicle, or which allows one or both members of the team to rest when the vehicle is parked.

While a variety of sleeper bunk or berth devices are known, there is a continued need for improved mattress supports.

### BRIEF DESCRIPTION

Disclosed is a vehicular mattress support platform comprising a perimeter portion and a central portion, wherein the central portion comprises ribs and open spaces located between the ribs and further wherein the perimeter portion and the central portion are formed from a reinforced polymer composition.

In addition to one or more of the features described above, or as an alternative to any of the foregoing embodiments, the perimeter portion comprises a continuous bottom surface and at least one rib disposed perpendicular to the continuous bottom surface.

In addition to one or more of the features described above, or as an alternative to any of the foregoing embodiments, the central portion ribs are perpendicular to the continuous bottom surface of the perimeter portion.

In addition to one or more of the features described above, or as an alternative to any of the foregoing embodiments, the central portion ribs are perpendicular to the at least one rib of the perimeter portion.

In addition to one or more of the features described above, or as an alternative to any of the foregoing embodiments, the perimeter portion comprises at least one attachment point for a wall attachment.

In addition to one or more of the features described above, or as an alternative to any of the foregoing embodiments, the perimeter portion comprises a front edge perpendicular to the continuous bottom surface.

In addition to one or more of the features described above, or as an alternative to any of the foregoing embodiments, the mattress support platform is non-planar.

In addition to one or more of the features described above, or as an alternative to any of the foregoing embodiments, the central portion ribs form a diamond pattern, square pattern, honeycomb pattern, circular pattern, rectangular pattern, triangular pattern, or combination thereof.

In addition to one or more of the features described above, or as an alternative to any of the foregoing embodiments, the sizes of the open spaces vary.

In addition to one or more of the features described above, or as an alternative to any of the foregoing embodiments, the open spaces in the middle of the central portion are smaller than the open spaces adjacent to the perimeter portion.

In addition to one or more of the features described above, or as an alternative to any of the foregoing embodiments, the central portion rib widths vary.

In addition to one or more of the features described above, or as an alternative to any of the foregoing embodiments, the mattress support platform further comprises an attachment point for a closure mechanism located on the perimeter portion adjacent to the front edge.

Also disclosed is a method of making a vehicular mattress support platform comprising providing a modular tool having a first section and a second section wherein the first section and a second section comprise rib channels, spaces between the rib channels and a mold for a continuous surface at a portion of the perimeter of the sections; locating the first section and the second so that the mold for a continuous surface is located at the perimeter of the combined first and second sections; and filling the tool with a reinforced polymer composition.

In addition to one or more of the features described above, or as an alternative to any of the foregoing embodiments, the method further comprises locating at least one expansion section having rib channels between the first section and the second section and aligning the expansion section rib channels with the first section rib channels and the second section rib channels.

In addition to one or more of the features described above, or as an alternative to any of the foregoing embodiments, the expansion section comprises a mold for a continuous surface.

Also disclosed is a method of making a mattress support platform comprising molding a modular form having a central portion, at least one intermediate portion, and a perimeter portion wherein the central portion comprises ribs and open spaces located between the ribs and the perimeter and intermediate portions each comprise a continuous bottom surface and at least one rib disposed perpendicular to the continuous bottom surface and further wherein the central portion, intermediate portion and perimeter portion comprise a reinforced polymer composition.

In addition to one or more of the features described above, or as an alternative to any of the foregoing embodiments, the method further comprises removing at least part of the perimeter portion so at least part of an intermediate portion is located at the perimeter and the length, width or length and width of the mattress support platform is reduced. Removing at least part of the perimeter portion may comprise milling, laser cutting, water jetting or a combination thereof. The remaining perimeter portion comprises at least one wall attachment point.

### BRIEF DESCRIPTION OF THE DRAWINGS

The following descriptions should not be considered limiting in any way. With reference to the accompanying drawings, like elements are numbered alike:

FIG. 1 is a top view of a mattress support platform;

FIG. 2 is a top side angle view of a mattress support platform;

FIGS. 3A-B is are views of mattress support platforms obtained using a modular mold; and

FIG. 4 shows a mattress support platform that may be reduced in size.

### DETAILED DESCRIPTION

A detailed description of one or more embodiments of the disclosed apparatus and method are presented herein by way of exemplification and not limitation with reference to the Figures.

Disclosed herein is a mattress support platform. The mattress support platform is suitable for use in a vehicle, particularly a truck, commercial vehicle, recreational vehicle, camping trailer or slide in camper. The mattress support platform offers adequate support for a mattress and a person sleeping on the mattress while also providing substantial weight savings over currently available mattress support platforms. Weight savings lead to greater fuel efficiency. Surprisingly the open spaces in the mattress support platform were not detected by persons reclined on a mattress supported by the mattress support platform.

FIG. 1 is a top view of a mattress support platform 10. The platform has a perimeter portion 20 and a central portion 30. The central portion 30 has ribs 40 and open spaces 50 located between the ribs. The mattress support may have at least one attachment location 80 for a portion of a wall attachment such as a hinge or the like. The mattress support may also have an attachment point for a portion of a closure mechanism 90. The perimeter portion 20 has ribs 70 which are perpendicular to a bottom surface 60.

The mattress support platform has a length 100 and a width 110. The mattress support platform has an area that is the product of the length 100 and the width 110. The bottom surface 60 of the perimeter portion may be 0 to 100%, or 2 to 20%, or, 3 to 10% of the mattress support platform area. The mattress support platform has an exterior edge 130 that is continuous over at least three sides of the mattress support platform. When a front edge 120 (described below) is present, the front edge may replace or supplement the exterior edge of the front side of the mattress support.

Open spaces 50 may have any shape. Exemplary shapes include diamonds, squares, honeycombs (hexagons), circles, rectangles, triangles, or a combination thereof. The open spaces 50 may vary in size. In some embodiments the open spaces in the middle of the central portion are smaller than the open spaces adjacent to the perimeter portion as shown in FIG. 4.

The height of the ribs in the central portion may be uniform or may vary. When the height of the ribs vary the mattress support platform may be non planar. For example, the ribs in the middle of the central portion may be shorter when the ribs near the perimeter are taller in order to more comfortably accommodate a sleeper. The central portion ribs may have a height which is based on structural requirements.

The width of the ribs in the central portion may be uniform or may vary. The rib width may be 1.4 to 5 millimeters (mm), or, 1.8 to 4 mm.

The perimeter portion 20 has a bottom surface 60 which is perpendicular to the ribs 70 of the perimeter portion. The ribs 70 of the perimeter portion may be perpendicular to at least one rib 40 of the central portion 30. The ribs 70 of the perimeter portion may continue the pattern of the central portion ribs 40 (as shown in FIG. 1) or may have a different pattern. The bottom surface 60 may have a thickness of 1.2 to 5 mm, or 1.8 to 4 mm.

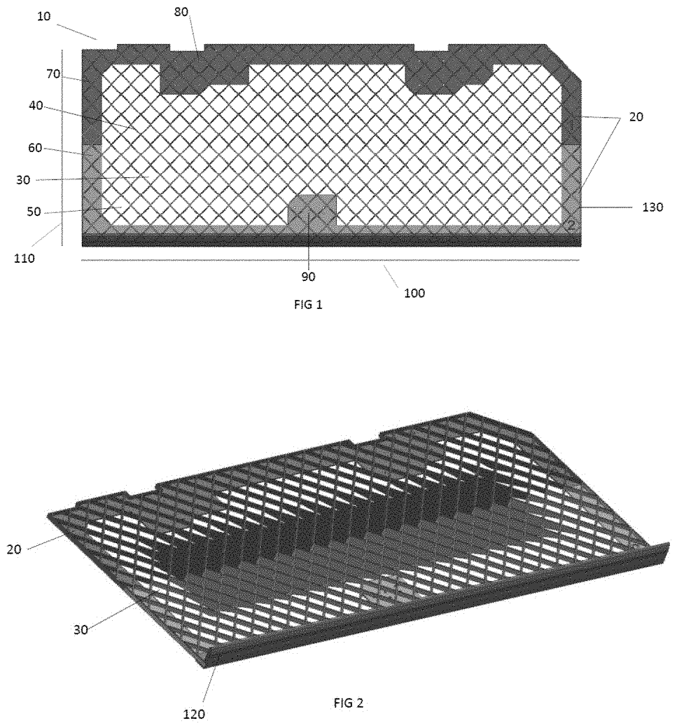

FIG. 2 is a top angle view of the mattress support platform shown in FIG. 1. FIG. 2 shows the front edge 120 of the mattress support platform. The front edge helps to retain the mattress on the mattress support platform. The front edge may have any desirable height. The front edge may be molded with the mattress support platform or may be attached at a later time.

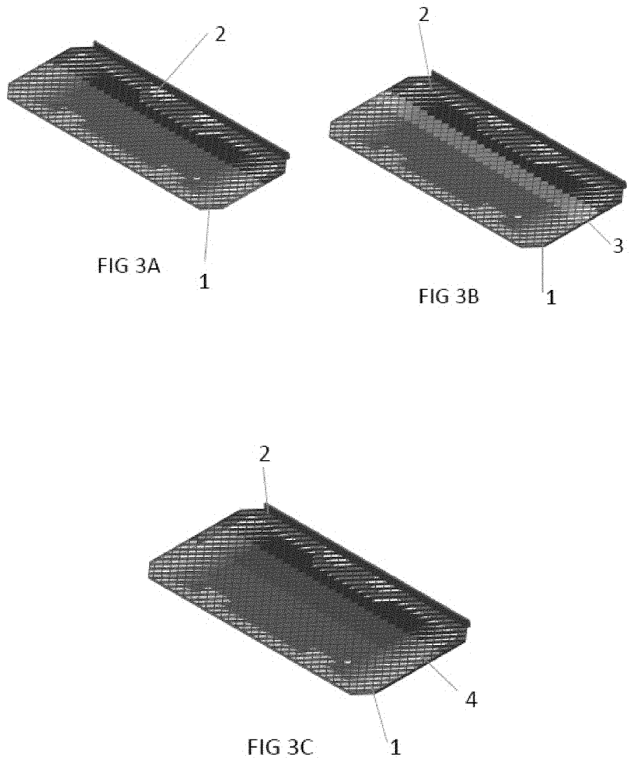

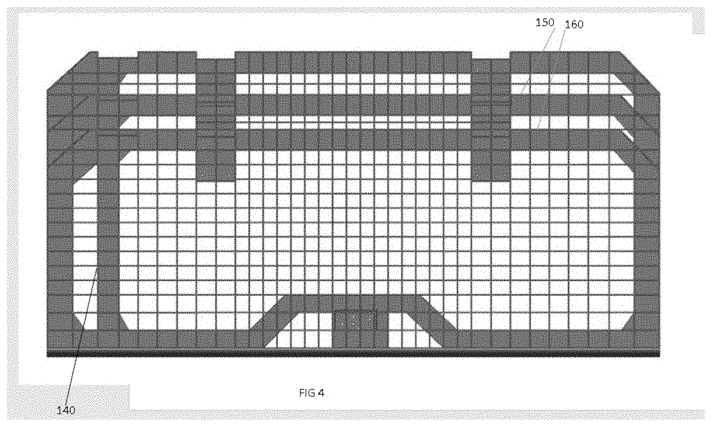

The mattress support platform may vary in size. The mold employed may be modular in order to simplify the tooling required to make different sizes and configurations. In this embodiment the mold has at least two portions that would result in two portions of the mattress support platform which are labeled 1 and 2 in FIG. 1. While these are shown as different portions this is merely for visualization and the actual mattress support platform is one continuous piece. The mold may include one or more additional portions that may expand the mattress support platform in length, width or both. An example is shown in FIGS. 3A-3C which show how the additional portions in the mold would result in differing size mattress support platforms. FIG. 3A shows a first portion 1 and a second portion 2, similar to FIG. 1. FIG. 3B shows a third portion 3 located between the first portion 1 and the second portion 2 which expands the width of the mattress support platform. FIG. 3C shows a fourth portion 4 located between the first portion 1 and the second portion 2 which expands the width of the mattress support platform to a different extent than the third portion shown in FIG. 3B. In each of these figures, the different portions are merely for visualization and the actual mattress support platform is one continuous piece.

In an alternate approach the mattress support platform is molded as a single blank with the various options of platform length and width built into a single mold and then the blank is reduced in size depending on the dimensions (length and width) required by the customer and application. The blank may be reduced in size by milling, laser cutting, water jetting or a combination thereof. The removed portion may be recycled. FIG. 4 shows a single blank with various size options obtainable by removing material. For example, the length can be reduced by removing material to leave 140 as an exterior edge. In a similar fashion the width may be reduced by removing material to leave 150 or 160 as an exterior edge.

The mattress support platform is formed from a reinforced polymer composition. Exemplary polymers include polypropylene or polyamide. Exemplary reinforcing materials include glass fiber, carbon fiber, a natural fiber such as cellulose (wood), hemp, jute or the like, and combination of the foregoing reinforcing materials.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A mattress support platform 10 comprising a perimeter portion and a central portion, wherein the central portion comprises ribs and open spaces located between the ribs and further wherein the perimeter portion and the central portion are formed from a reinforced polymer composition.

2. The mattress support platform of claim 1, wherein the perimeter portion comprises a continuous bottom surface 60 and at least one rib 70 disposed perpendicular to the continuous bottom surface.

3. The mattress support platform of claim 2, wherein the central portion ribs are perpendicular to the continuous bottom surface of the perimeter portion.

4. The mattress support platform of claim 3, wherein the central portion ribs are perpendicular to the at least one rib of the perimeter portion.

5. The mattress support platform of claim 1, wherein the perimeter portion comprises at least one attachment point 80 for a hinge.

6. The mattress support platform of claim 1, wherein the perimeter portion comprises a front edge 100 perpendicular to the continuous bottom surface.

7. The mattress support platform of claim 6, further comprising an attachment point 90 for a closure mechanism located on the perimeter portion adjacent to the front edge.

8. The mattress support platform of claim 1, wherein the mattress support platform is non-planar.

9. The mattress support platform of claim 1, wherein the central portion ribs form a diamond pattern, square pattern, honeycomb pattern, circular pattern, rectangular pattern, triangular pattern, or combination thereof.

10. The mattress support platform of claim 1, wherein the size of the open spaces varies.

11. The mattress support platform of claim 10, wherein the open spaces in the middle of the central portion are smaller than the open spaces adjacent to the perimeter portion.

12. The mattress support platform of claim 1, wherein the central portion ribs have a height and a width and the height of the central portion ribs varies.

13. The mattress support platform of claim 12, wherein the central portion rib width varies.

14. A method of making a mattress support platform comprising
providing a modular tool having a first section and a second section wherein the first section and a second section comprise rib channels, spaces between the rib channels and a mold for a continuous surface at a portion of the perimeter of the sections;
locating the first section and the second so that the mold for a continuous surface is located at the perimeter of the combined first and second sections; and
filling the tool with a reinforced polymer composition.

15. The method of claim 14, further comprising locating at least one expansion section having rib channels between the first section and the second section and aligning the expansion section rib channels with the first section rib channels and the second section rib channels.

16. The method of claim 15, wherein the expansion section comprises a mold for a continuous surface.

17. A method of making a mattress support platform comprising molding a modular form having a central portion, at least one intermediate portion, and a perimeter portion wherein the central portion comprises ribs and open spaces located between the ribs and the perimeter and intermediate portions each comprise a continuous bottom surface and at least one rib disposed perpendicular to the continuous bottom surface and further wherein the central portion, intermediate portion and perimeter portion comprise a reinforced polymer composition.

18. The method of claim 17, further comprising removing at least part of the perimeter portion so at least part of an intermediate portion is located at the perimeter and the length, width or length and width of the mattress support platform is reduced.

19. The method of claim 18, wherein removing at least part of the perimeter portion comprises milling, laser cutting, water jetting or a combination thereof.

20. The method of claim 18, wherein the remaining perimeter portion comprises at least one wall attachment point.
